(19) United States
(12) Patent Application Publication
(10) Pub. No.: US 2016/0170430 A1
(43) Pub. Date: Jun. 16, 2016

(54) REFERENCE CIRCUIT

(71) Applicant: Kabushiki Kaisha Toshiba, Tokyo (JP)

(72) Inventor: Norihiro Ueda, Kawasaki Kanagawa (JP)

(21) Appl. No.: 14/848,988

(22) Filed: Sep. 9, 2015

(30) Foreign Application Priority Data
Dec. 16, 2014 (JP) 2014-254430

(51) Int. Cl. G05F 3/02

(52) U.S. Cl. CPC G05F 3/02

(57) ABSTRACT

The reference circuit includes a first switch element that is connected to the first node at a first end of a current path thereof. The reference circuit includes a first capacitive element that is connected to a second end of the current path of the first switch element at a first end thereof and to a fixed potential at a second end thereof. The reference circuit includes an output circuit that outputs a third voltage that is based on a second voltage at the first end of the first capacitive element. The reference circuit includes a comparator that compares a fourth voltage correlated with the second voltage and a fifth voltage and outputs a comparison result signal in accordance with a result of the comparison. The reference circuit includes a controlling circuit that controls operation of the voltage generating circuit and the first switch element.

### CROSS-REFERENCE TO RELATED APPLICATION

This application is based upon and claims the benefit of priority from the prior Japanese Patent Application No. 2014-254430, filed on Dec. 16, 2014, the entire contents of which are incorporated herein by reference.

### BACKGROUND

1. Field

Embodiments described herein relate generally to a reference circuit.

2. Background Art

A conventional reference circuit has an oscillating circuit and a controlling circuit that make a reference voltage generating circuit, which consumes a large amount of current, operate intermittently in order to reduce the consumed current of the circuit.

The conventional reference circuit transitions between a sampling state and a holding state.

For example, in the sampling state, the reference voltage generating circuit and a sampling switch are turned on, and a capacitive element is charged with a reference voltage through the sampling switch.

On the other hand, in the holding state, the reference voltage generating circuit and the sampling switch are turned off, and the capacitive element dynamically holds a hold voltage.

With the conventional reference circuit, switching between the sampling state and the holding state is temporally controlled. The greater the control duty in the holding state, the more the consumed current can be reduced.

The sampling switch is constituted by a MOS transistor, so that a leak current occurs in the off state. The leak current highly depends on the temperature characteristics and increases at high temperatures.

With the conventional reference circuit described above, the control duty needs to be set to the current at high temperatures, which is the worst case scenario.

As a result, at room temperature, an excessive number of samplings occur although the leak current decreases. This leads to a problem that current is consumed uselessly.

### BRIEF DESCRIPTION OF THE DRAWINGS

FIG. 1 is a circuit diagram showing an example of a configuration of a reference circuit 100 according to a first embodiment;

FIG. 2 is a characteristic diagram showing an example of a relationship between the detected voltage “VDET” and hold voltage “VHOLD” and time in the holding state;

FIG. 3 is a characteristic diagram showing an example of a relationship between the leak current of a switch element in the off state and temperature;

FIG. 4 is a waveform diagram showing an example of signal waveforms of the reference circuit 100 shown in FIG. 1 in the sampling state and the holding state;

FIG. 5 is a diagram showing an example of a relationship between the on duty of the first switch element “SW1” of the reference circuit 100 shown in FIG. 1 and temperature;

FIG. 6 is a circuit diagram showing an example of a configuration of a reference circuit 200 according to a second embodiment;

FIG. 7 is a waveform diagram showing an example of signal waveforms of the reference circuit 200 shown in FIG. 6 in the sampling state and the holding state;

FIG. 8 is a circuit diagram showing an example of a configuration of a reference circuit 300 according to a third embodiment;

FIG. 9 is a circuit diagram showing an example of a configuration of a reference circuit 400 according to a fourth embodiment;

FIG. 10 is a waveform diagram showing an example of signal waveforms of the reference circuit 400 shown in FIG. 9 in the sampling state and the holding state;

FIG. 11 is a circuit diagram showing an example of a configuration of a reference circuit 500 according to a fifth embodiment; and

FIG. 12 is a circuit diagram showing an example of a configuration of a reference circuit 600 according to a sixth embodiment.

### DETAILED DESCRIPTION

A reference circuit according to an embodiment includes a voltage generating circuit that outputs a first voltage to a first node. The reference circuit includes a first switch element that is connected to the first node at a first end of a current path thereof. The reference circuit includes a first capacitive element that is connected to a second end of the current path of the first switch element at a first end thereof and to a fixed potential at a second end thereof. The reference circuit includes an output circuit that outputs a third voltage that is based on a second voltage at the first end of the first capacitive element. The reference circuit includes a comparator that compares a fourth voltage correlated with the second voltage and a fifth voltage and outputs a comparison result signal in accordance with a result of the comparison. The reference circuit includes a controlling circuit that controls operation of the voltage generating circuit and the first switch element in accordance with the comparison result signal.

In the following, embodiments will be described with reference to the drawings.

### First Embodiment

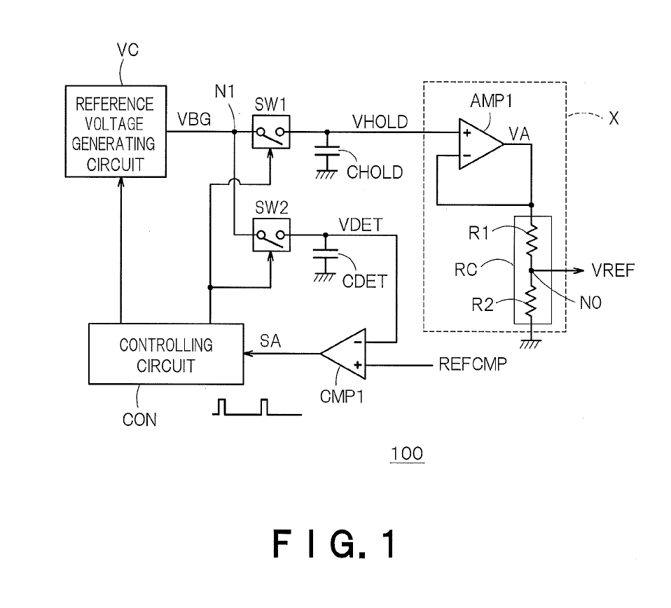

FIG. 1 is a circuit diagram showing an example of a configuration of a reference circuit 100 according to a first embodiment.

As shown in FIG. 1, the reference circuit 100 includes a reference voltage generating circuit “VC”, a first switch element “SW1”, a second switch element “SW2”, a first capacitive element “CHOLD”, a second capacitive element “CDET”, an output circuit “X”, a comparator “CMP1”, and a controlling circuit “CON”.

The reference voltage generating circuit “VC” generates and outputs a constant reference voltage “VBG” with reduced influence of a power supply voltage of a power supply and temperature. In this example, the reference voltage generating circuit “VC” is connected to a first node “N1” at an output thereof and outputs the reference voltage “VBG” to the first node “N1”. The reference voltage “VBG” that is output when the reference voltage generating circuit “VC” is being driven is higher than a ground potential. The reference voltage “VBG” that is output when the reference voltage generating circuit “VC” is not operating is 0V (ground potential).

The first switch element “SW1” is connected to the first node “N1” at one end of a current path thereof.

The first capacitive element “CHOLD” is connected to another end of the current path of the first switch element “SW1” at one end thereof and to a fixed potential (ground potential, for example) at another end thereof.

The output circuit “X” outputs a reference voltage (output voltage) “VREF” that is based on a hold voltage “VHOLD” at the one end of the first capacitive element “CHOLD”.

As shown in FIG. 1, the output circuit “X” includes an amplifying circuit “AMP1” (non-inverting amplifier) and a voltage dividing circuit “RC”, for example.

In the example shown in FIG. 1, a non-inverting input terminal of the amplifying circuit “AMP1” is connected to the one end of the first capacitive element “CHOLD” and receives the hold voltage “VHOLD”. An inverting input terminal of the amplifying circuit “AMP1” is connected to an output of the amplifying circuit “AMP1” and receives an amplifier voltage “VA”.

The amplifying circuit “AMP1” controls the amplifier voltage “VA” so as to make the amplifier voltage “VA” equal to the hold voltage “VHOLD”.

The voltage dividing circuit “RC” is connected between the output of the amplifying circuit “AMP1” and the fixed potential (ground potential). The voltage dividing circuit “RC” outputs, as the reference voltage “VREF”, a voltage obtained by dividing the amplifier voltage “VA” output from the amplifying circuit “AMP1” in a first voltage dividing ratio.

As shown in FIG. 1, the voltage dividing circuit “RC” includes a first resistive element “R1” and a second resistive element “R2”, for example.

The first resistive element “R1” is connected to the output of the amplifying circuit “AMP1” at one end thereof and to an output node “NO” at which the reference voltage “VREF” is output at another end thereof.

The second resistive element “R2” is connected to the output node “NO” at one end thereof and to the fixed potential (ground potential) at another end thereof.

As described above, in the example shown in FIG. 1, the voltage dividing circuit “RC” outputs, as the reference voltage “VREF”, a voltage obtained by dividing the amplifier voltage “VA” in the first voltage dividing ratio determined by the first and second resistive elements “R1” and “R2”.

The amplifying circuit “AMP1” may control the output voltage “VA” of the amplifying circuit “AMP1” so as to make the output voltage “VA” equal to the hold voltage “VHOLD” and output the output voltage “VA” of the amplifying circuit “AMP1” as the reference voltage “VREF”.

The second switch element “SW2” is connected to the first node “N1” at one end of a current path thereof.

A leak current of the second switch element “SW2” in the off state is set to be proportional to a leak current of the first switch element “SW1” in the off state. For example, in the first embodiment, the leak current of the second switch element “SW2” in the off state is set to be equal to the leak current of the first switch element “SW1” in the off state.

The second capacitive element “CDET” is connected to another end of the current path of the second switch element “SW2” at one end thereof and to the fixed potential (ground potential) at another end thereof. The second capacitive element “CDET” has a capacitance smaller than a capacitance of the first capacitive element “CHOLD”.

That is, the ratio of the capacitance of the first capacitive element “CHOLD” to the capacitance of the second capacitive element “CDET” is R to 1 (R>1).

A detected voltage “VDET” is the voltage at the one end of the second capacitive element “CDET”. Therefore, a voltage variation “ΔVDET” of the detected voltage “VDET” is proportional to a voltage variation “ΔVHOLD” of the hold voltage “VHOLD” (R times as high as the voltage variation “ΔVHOLD” of the hold voltage “VHOLD”).

The first switch element “SW1” described above is a MOS transistor that is connected to the first node “N1” at one end (drain) of a current path thereof and to the one end of the first capacitive element “CHOLD” at another end (source) of the current path and has a gate voltage at a control end (gate) thereof controlled by the controlling circuit “CON”, for example. The second switch element “SW2” is a MOS transistor that is connected to the first node “N1” at one end (drain) of a current path thereof and to the one end of the second capacitive element “CDET” at another end (source) of the current path and has a gate voltage at a control end (gate) thereof controlled by the controlling circuit “CON”, for example.

In the first embodiment, the leak current of the MOS transistor serving as the second switch element “SW2” in the off state is set to be equal to the leak current of the MOS transistor serving as the first switch element “SW1” in the off state.

That is, a driving power of the MOS transistor serving as the second switch element “SW2” is set to be equal to a driving power of the MOS transistor serving as the first switch element “SW1”.

In other words, a gate width of the MOS transistor serving as the second switch element “SW2” is set to be equal to a gate width of the MOS transistor serving as the first switch element “SW1”.

As described above, the first and second switch elements “SW1” and “SW2” are matched sampling switches.

As described above, if the leak currents of the first and second switch elements “SW1” and “SW2” are equal to each other, and the first and second switch elements “SW1” and “SW2” are turned on and off in synchronization with each other, when the ratio of the capacitance of the first capacitive element “CHOLD” to the capacitance of the second capacitive element “CDET” is R to 1 (R>1), the voltage variation “ΔVDET” of the detected voltage “VDET” is proportional to the voltage variation “ΔVHOLD” of the hold voltage “VHOLD”.

The comparator “CMP1” compares the detected voltage “VDET” correlated with the hold voltage “VHOLD” with a comparison voltage “REFCMP” and outputs a comparison result signal “SA” in accordance with the result of the comparison.

In this example, the detected voltage “VDET” is input to an inverting input terminal of the comparator “CMP1”, and the comparison voltage “REFCMP” is input to a non-inverting input terminal of the comparator “CMP1”.

In this example, the comparison voltage “REFCMP” is set to be lower than the reference voltage “VBG”.

For example, if the detected voltage “VDET” is equal to or higher than the comparison voltage “REFCMP”, the comparator “CMP1” outputs the comparison result signal “SA” at a “Low” revel.

On the other hand, once the detected voltage “VDET” reaches (decreases to) the comparison voltage “REFCMP”, the comparator “CMP1” outputs the comparison result signal “SA” at a “High” revel for a predetermined period.

The comparator “CMP1” may have a hysteresis characteristic, for example. In that case, the noise resistance of the comparison operation of the comparator “CMP1” can be improved.

The controlling circuit “CON” controls operation of the reference voltage generating circuit “VC” and the first and second switch elements “SW1” and “SW2” in accordance with the comparison result signal “SA”.

For example, if the detected voltage “VDET” lies between the reference voltage “VBG” and the comparison voltage “REFCMP”, that is, if the detected voltage “VDET” is equal to or higher than the comparison voltage “REFCMP” in this embodiment, the comparison result signal “SA” indicates a first state, and the controlling circuit “CON” makes the reference voltage generating circuit “VC” stop operating and turns off the first switch element “SW1” and the second switch element “SW2”.

As a result, supply of the reference voltage “VBG” to the first and second capacitive elements “CHOLD” and “CDET” is stopped, and a holding state is entered.

If the comparison result signal “SA” indicates a second state in which the detected voltage “VDET” has reached the comparison voltage “REFCMP”, the controlling circuit “CON” makes the reference voltage generating circuit “VC” operate for a predetermined period, and turns on the first and second switch elements “SW1” and “SW2”.

As a result, supply of the reference voltage “VBG” to the first and second capacitive elements “CHOLD” and “CDET” is started, and a sampling state is entered.

Next, characteristics of the operation of the reference circuit 100 configured as described above will be described.

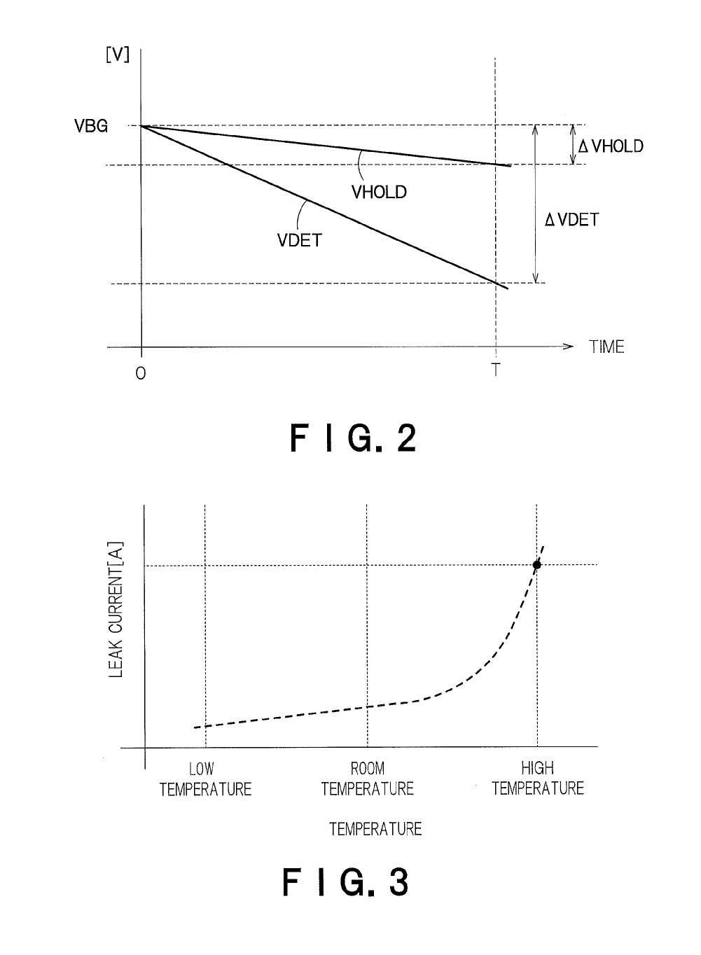

FIG. 2 is a characteristic diagram showing an example of a relationship between the detected voltage “VDET” and hold voltage “VHOLD” and time in the holding state.

Suppose that a change from the sampling state to the holding state occurs at a time 0. Then, at the time 0, the hold voltage “VHOLD” is equal to the detected voltage “VDET” (=reference voltage “VBG”).

As described above, the matched first and second switch elements “SW1” and “SW2” ideally pass an equal leak current in the off state. Therefore, the voltage variation “ΔVHOLD” of the hold voltage “VHOLD” and the voltage variation “ΔVDET” of the detected voltage “VDET” in a period from the time 0 to a time “T” are related to each other according to the following formula (1).

ΔVHOLD=ΔVDET/R (1)

Note that FIG. 2 shows the detected voltage “VDET” and the hold voltage “VHOLD” under a voltage condition that the reference voltage “VBG” in the sampling state is higher than the reference voltage “VBG” in the holding state.

FIG. 3 is a characteristic diagram showing an example of a relationship between the leak current of a switch element in the off state and temperature.

Since the first and second switch elements “SW1” and “SW2” are formed by MOS transistors as described above, a leak current flows in the off state. The leak current substantially depends on the temperature characteristics and increases at high temperatures. Although the switch elements are described as MOS transistors in this embodiment, the present invention is not limited to this implementation. This embodiment is advantageous for any switch element in which a leak current occurs in the off state. The same holds true for the embodiments described later.

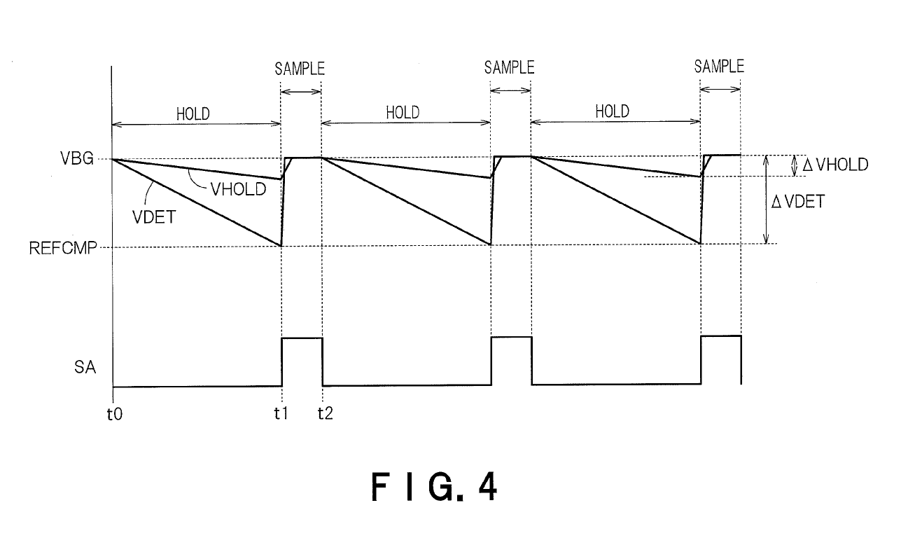

FIG. 4 is a waveform diagram showing an example of signal waveforms of the reference circuit 100 shown in FIG. 1 in the sampling state and the holding state. In the example shown in FIG. 4, the comparison voltage “REFCMP” is set at a constant value.

As described above, switching between the sampling state and the holding state is achieved through voltage control based on comparison by the comparator “CMP1”.

For example, if the comparison result signal “SA” indicates the first state in which the detected voltage “VDET” is equal to or higher than the comparison voltage “REFCMP” (such as the state in a period from a time “t0” to a time “t1” in FIG. 4), the controlling circuit “CON” makes the reference voltage generating circuit “VC” stop operating and turns off the first switch element “SW1” and the second switch element “SW2”.

As a result, supply of the reference voltage “VBG” to the first and second capacitive elements “CHOLD” and “CDET” is stopped, and the holding state is entered.

That is, in the holding state, the reference voltage generating circuit “VC” and the first and second switch elements “SW1” and “SW2” are in the off state, the first capacitive element “CHOLD” dynamically holds the hold voltage “VHOLD”, and the second capacitive element “CDET” dynamically holds the detected voltage “VDET”.

On the other hand, if the comparison result signal “SA” indicates the second state in which the detected voltage “VDET” has reached the comparison voltage “REFCMP” (such as the state at the time “t1” in FIG. 4), the controlling circuit “CON” makes the reference voltage generating circuit “VC” operate for a predetermined period (such as a period from the time “t1” to a time “t2” in FIG. 4), and turns on the first switch element “SW1” and the second switch element “SW2”.

As a result, supply of the reference voltage “VBG” to the first and second capacitive elements “CHOLD” and “CDET” is started, and the sampling state is entered.

That is, in the sampling state, the reference voltage generating circuit “VC” and the first and second switch elements “SW1” and “SW2” are in the on state and the first and second capacitive elements “CHOLD” and “CDET” are charged with the reference voltage “VBG” through the first and second switch element “SW1” and “SW2”, respectively.

For example, the comparison voltage “REFCMP” of the comparator “CMP1” is set at the value expressed by the following formula (2). The voltage variation “ΔVDET” is detected, and the state transitions to the sampling state. Then, the potential variation (ripple) of the hold voltage “VHOLD” is the voltage variation “ΔVHOLD” (formula (1)).

REFCMP=VBG−ΔVDET (2)

The time “T” shown in FIG. 2 (the period from the time “t0” to the time “t1” in FIG. 4) is expressed by the following formula (3).

T=(ΔVDET×CDET)/leak current (3)

The time “T” depends on the leak current in the off state. Therefore, even if the leak current varies significantly, sampling can be achieved with an appropriate control duty. As a result, the consumed current of the reference circuit can be reduced.

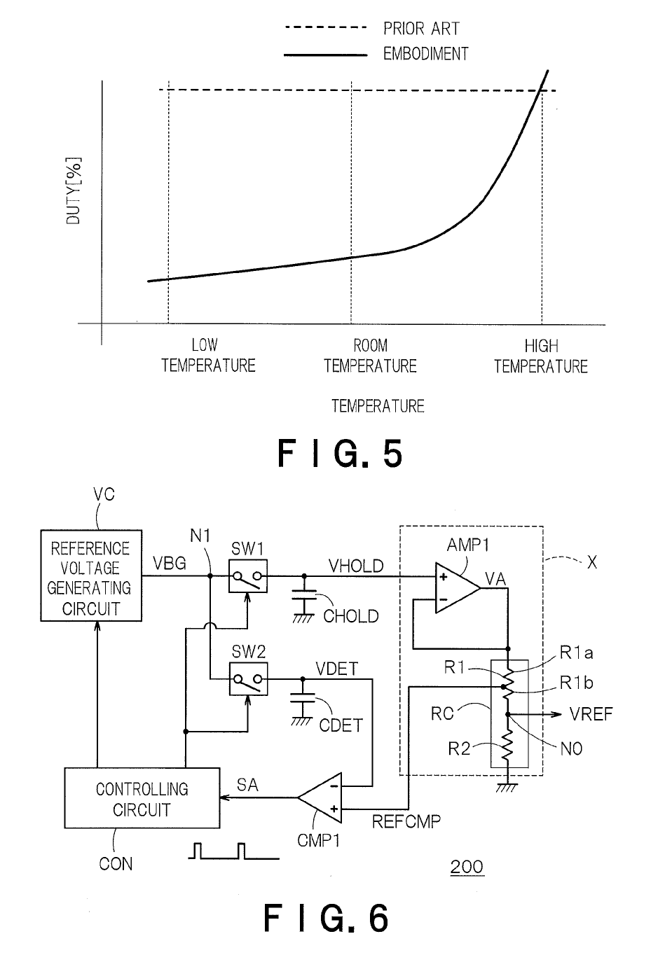

FIG. 5 is a diagram showing an example of a relationship between the on duty of the first switch element “SW1” of the reference circuit 100 shown in FIG. 1 and temperature. In FIG. 5, the solid line indicates a characteristic according to this embodiment, and the dotted line indicates a characteristic in a comparative example.

The sample-hold control duty (on-duty of the first and second switch elements “SW1” and “SW2”) varies with the leak current of the first and second switch elements “SW1” and “SW2” in the off state. Therefore, when the leak current is small, the number of samplings decreases, so that the wasted current can be eliminated, and the consumed current can be reduced.

As described above, the reference circuit according to the first embodiment can reduce the consumed current.

### Second Embodiment

FIG. 6 is a circuit diagram showing an example of a configuration of a reference circuit 200 according to a second embodiment. In FIG. 6, the same reference symbols as those in FIG. 1 denote the same components as those in the first embodiment, and description of the components will be omitted.

As shown in FIG. 6, as with the reference circuit 100 according to the first embodiment, the reference circuit 200 includes the reference voltage generating circuit “VC”, the first switch element “SW1”, the second switch element “SW2”, the first capacitive element “CHOLD”, the second capacitive element “CDET”, the output circuit “X”, the comparator “CMP1”, and the controlling circuit “CON”.

According to the second embodiment, as shown in FIG. 6, the comparison voltage “REFCMP” is a voltage obtained by the voltage dividing circuit “RC” dividing the amplifier voltage “VA”. Therefore, according to this embodiment, the comparison voltage “REFCMP” varies with the reference voltage “VREF”.

Since the reference circuit 200 can provide the comparison voltage “REFCMP” for itself, the circuit that generates the comparison voltage “REFCMP” can be omitted.

The remainder of the configuration of the reference circuit 200 is the same as that of the reference circuit 100 shown in FIG. 1.

Next, characteristics of the operation of the reference circuit 200 configured as described above will be described.

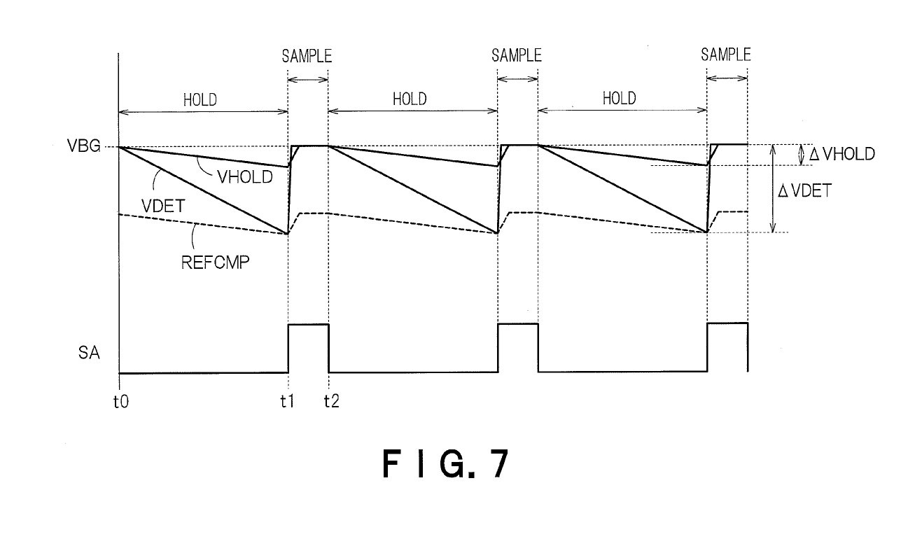

FIG. 7 is a waveform diagram showing an example of signal waveforms of the reference circuit 200 shown in FIG. 6 in the sampling state and the holding state. As described above, in the example shown in FIG. 7, the comparison voltage “REFCMP” varies with the reference voltage “VREF”.

As in the first embodiment, switching between the sampling state and the holding state is achieved through voltage control based on comparison by the comparator “CMP1”.

As in the first embodiment, if the detected voltage “VDET” lies between the reference voltage “VBG” and the comparison voltage “REFCMP”, that is, if the detected voltage “VDET” is equal to or higher than the comparison voltage “REFCMP” in this embodiment, the comparison result signal “SA” indicates the first state (such as the state in the period from the time “t0” to the time “t1” in FIG. 7), and the controlling circuit “CON” makes the reference voltage generating circuit “VC” stop operating and turns off the first switch element “SW1” and the second switch element “SW2”.

As a result, supply of the reference voltage “VBG” to the first and second capacitive elements “CHOLD” and “CDET” is stopped, and the holding state is entered.

If the comparison result signal “SA” indicates the second state in which the detected voltage “VDET” has reached the comparison voltage “REFCMP” (such as the state at the time “t1” in FIG. 7), the controlling circuit “CON” makes the reference voltage generating circuit “VC” operate for a predetermined period (such as the period from the time “t1” to the time “t2” in FIG. 7), and turns on the first and second switch elements “SW1” and “SW2”.

As a result, supply of the reference voltage “VBG” to the first and second capacitive elements “CHOLD” and “CDET” is started, and the sampling state is entered.

The remainder of the characteristics of the operation of the reference circuit 200 configured as described above is the same as that of the reference circuit 100 according to the first embodiment.

That is, as with the reference circuit 100 according to the first embodiment, the reference circuit 200 according to the second embodiment can reduce the consumed current.

### Third Embodiment

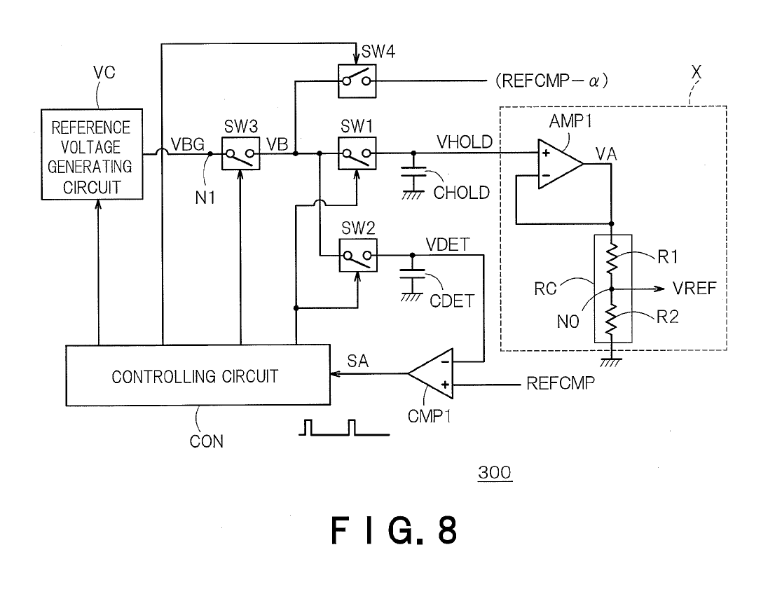

FIG. 8 is a circuit diagram showing an example of a configuration of a reference circuit 300 according to a third embodiment. In FIG. 8, the same reference symbols as those in FIG. 1 denote the same components as those in the first embodiment, and description of the components will be omitted.

As shown in FIG. 8, as with the reference circuit 100 according to the first embodiment, the reference circuit 300 includes the reference voltage generating circuit “VC”, the first switch element “SW1”, the second switch element “SW2”, the first capacitive element “CHOLD”, the second capacitive element “CDET”, the output circuit “X”, the comparator “CMP1”, and the controlling circuit “CON”.

The reference circuit 300 according to the third embodiment differs from the reference circuit 100 according to the first embodiment in that the reference circuit 300 further includes a third switch element “SW3” and a fourth switch element “SW4”.

A current path of the third switch element “SW3” is connected between the first node “N1” and the one ends of the first and second switch elements “SW1” and “SW2”. The third switch element “SW3” operates under the control of the controlling circuit “CON”.

The fourth switch element “SW4” is connected to the one ends of the first and second switch elements “SW1” and “SW2” at one end of a current path thereof, and a control voltage (REFCMP−α) is applied to another end of the current path. The fourth switch element “SW4” operates under the control of the controlling circuit “CON”.

As in the first embodiment, the comparator “CMP1” compares the detected voltage “VDET” correlated with the hold voltage “VHOLD” with the comparison voltage “REFCMP” and outputs the comparison result signal “SA” in accordance with the result of the comparison.

The detected voltage “VDET” is input to the inverting input terminal of the comparator “CMP1”, and the comparison voltage “REFCMP” is input to the non-inverting input terminal of the comparator “CMP1”.

The control voltage (REFCMP−α) is set to be lower than the comparison voltage “REFCMP”.

If the detected voltage “VDET” lies between the reference voltage “VBG” and the comparison voltage “REFCMP”, that is, if the detected voltage “VDET” is equal to or higher than the comparison voltage “REFCMP” in this embodiment, the comparison result signal “SA” indicates the first state described above, and the controlling circuit “CON” makes the reference voltage generating circuit “VC” stop operating, turns off the first to third switch elements “SW1” to “SW3” and then turns on the fourth switch element “SW4”.

As a result, supply of the reference voltage “VBG” to the first and second capacitive elements “CHOLD” and “CDET” is stopped, and the holding state is entered.

The voltage “VB” at the one ends of the first and second switch elements “SW1” and “SW2” then becomes equal to the control voltage (REFCMP−α) and is higher than the potential (ground potential) of the reference voltage “VBG” in the holding state in the first embodiment. Thus, the potential difference between the terminals of the first and second switch elements “SW1” and “SW2” decreases, and the absolute values of the leak currents of the first and second switch elements “SW1” and “SW2” can be reduced.

After that, if the comparison result signal “SA” indicates the second state described above in which the detected voltage “VDET” has reached the comparison voltage “REFCMP”, the controlling circuit “CON” makes the reference voltage generating circuit “VC” operate for a predetermined period, and turns on the first to third switch elements “SW1” to “SW3”.

As a result, supply of the reference voltage “VBG” to the first and second capacitive elements “CHOLD” and “CDET” is started, and the sampling state is entered.

As described above, in the holding state, the voltage “VB” at the one ends of the first and second switch elements “SW1” and “SW2” is made equal to the control voltage (REFCMP−α) to control the voltages between the terminals of the first and second switch elements “SW1” and “SW2”.

In this way, the absolute values of the leak currents of the first and second switch elements “SW1” and “SW2” are reduced. As a result, the period of the holding state of the reference circuit 300 can be extended, and the consumed current can be reduced.

The remainder of the configuration of the reference circuit 300 is the same as that of the reference circuit 100 shown in FIG. 1.

The remainder of the characteristics of the operation of the reference circuit 300 configured as described above is the same as that of the reference circuit 100 according to the first embodiment.

That is, as with the reference circuit 100 according to the first embodiment, the reference circuit 300 according to the third embodiment can reduce the consumed current.

### Fourth Embodiment

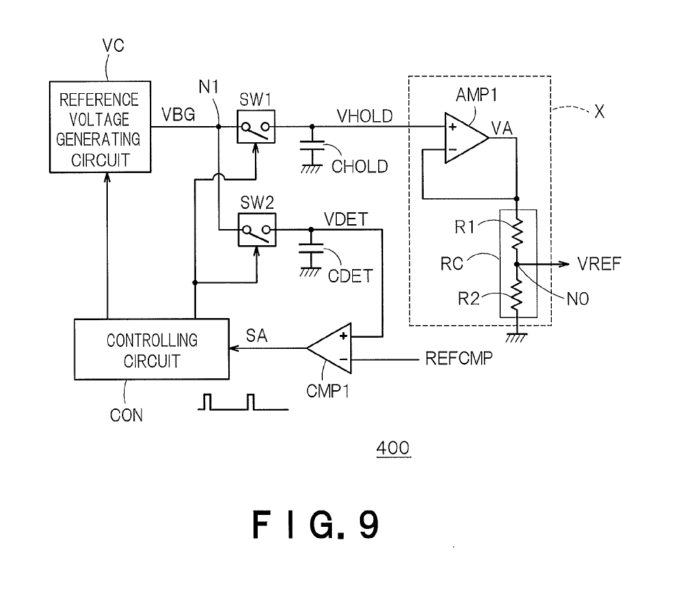

FIG. 9 is a circuit diagram showing an example of a configuration of a reference circuit 400 according to a fourth embodiment. In FIG. 9, the same reference symbols as those in FIG. 1 denote the same components as those in the first embodiment, and description of the components will be omitted.

As shown in FIG. 9, as with the reference circuit 100 according to the first embodiment, the reference circuit 400 includes the reference voltage generating circuit “VC”, the first switch element “SW1”, the second switch element “SW2”, the first capacitive element “CHOLD”, the second capacitive element “CDET”, the output circuit “X”, the comparator “CMP1”, and the controlling circuit “CON”.

The comparator “CMP1” compares the detected voltage “VDET” correlated with the hold voltage “VHOLD” with the comparison voltage “REFCMP” and outputs the comparison result signal “SA” in accordance with the result of the comparison.

According to the fourth embodiment, the comparison voltage “REFCMP” is input to the inverting input terminal of the comparator “CMP1”, and the detected voltage “VDET” is input to the non-inverting input terminal of the comparator “CMP1”.

In this example, the comparison voltage “REFCMP” is set to be higher than the reference voltage “VBG”.

For example, if the detected voltage “VDET” is lower than the comparison voltage “REFCMP”, the comparator “CMP1” outputs the comparison result signal “SA” at the “Low” revel.

On the other hand, once the detected voltage “VDET” reaches (increases to) the comparison voltage “REFCMP”, the comparator “CMP1” outputs the comparison result signal “SA” at the “High” revel for a predetermined period.

The remainder of the configuration of the reference circuit 400 is the same as that of the reference circuit 100 shown in FIG. 1.

Next, characteristics of the operation of the reference circuit 400 configured as described above will be described.

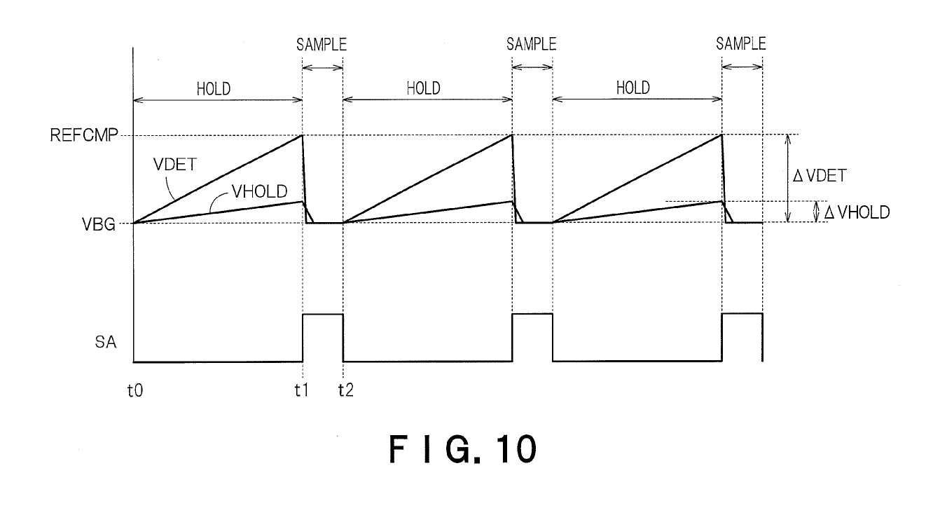

FIG. 10 is a waveform diagram showing an example of signal waveforms of the reference circuit 400 shown in FIG. 9 in the sampling state and the holding state. As described above, in the example shown in FIG. 10, the comparison voltage “REFCMP” is set to be higher than the reference voltage “VBG”. When the reference voltage generating circuit “VC” is not operating, the reference voltage “VBG” is set at a higher potential (power supply potential, for example).

For example, if the detected voltage “VDET” lies between the reference voltage “VBG” and the comparison voltage “REFCMP”, that is, if the detected voltage “VDET” is equal to or lower than the comparison voltage “REFCMP” in this embodiment, the comparison result signal “SA” indicates the first state (such as the state in the period from the time “t0” to the time “t1” in FIG. 10), and the controlling circuit “CON” makes the reference voltage generating circuit “VC” stop operating and turns off the first switch element “SW1” and the second switch element “SW2”.

As a result, supply of the reference voltage “VBG” to the first and second capacitive elements “CHOLD” and “CDET” is stopped, and the holding state is entered.

That is, in the holding state, the reference voltage generating circuit “VC” and the first and second switch elements “SW1” and “SW2” are in the off state, the first capacitive element “CHOLD” dynamically holds the hold voltage “VHOLD”, and the second capacitive element “CDET” dynamically holds the detected voltage “VDET”.

If the comparison result signal “SA” indicates the second state in which the detected voltage “VDET” has reached the comparison voltage “REFCMP” (such as the state at the time “t1” in FIG. 10), the controlling circuit “CON” makes the reference voltage generating circuit “VC” operate for a predetermined period (such as the period from the time “t1” to the time “t2” in FIG. 10), and turns on the first switch element “SW1” and the second switch element “SW2”.

As a result, supply of the reference voltage “VBG” to the first and second capacitive elements “CHOLD” and “CDET” is started, and the sampling state is entered.

That is, in the sampling state, the reference voltage generating circuit “VC” and the first and second switch elements “SW1” and “SW2” are in the on state, and the first and second capacitive elements “CHOLD” and “CDET” are charged with the reference voltage “VBG” through the first and second switch elements “SW1” and “SW2”, respectively.

As in the first embodiment, the sample-hold control duty (on-duty of the first and second switch elements “SW1” and “SW2”) varies with the leak current of the first and second switch elements “SW1” and “SW2” in the off state. Therefore, when the leak current is small, the number of samplings decreases, so that the wasted current can be eliminated, and the consumed current can be reduced.

As described above, the characteristics of the operation of the reference circuit 400 is the same as those of the reference circuit 100 according to the first embodiment.

That is, as with the reference circuit 100 according to the first embodiment, the reference circuit 400 according to the fourth embodiment can reduce the consumed current.

### Fifth Embodiment

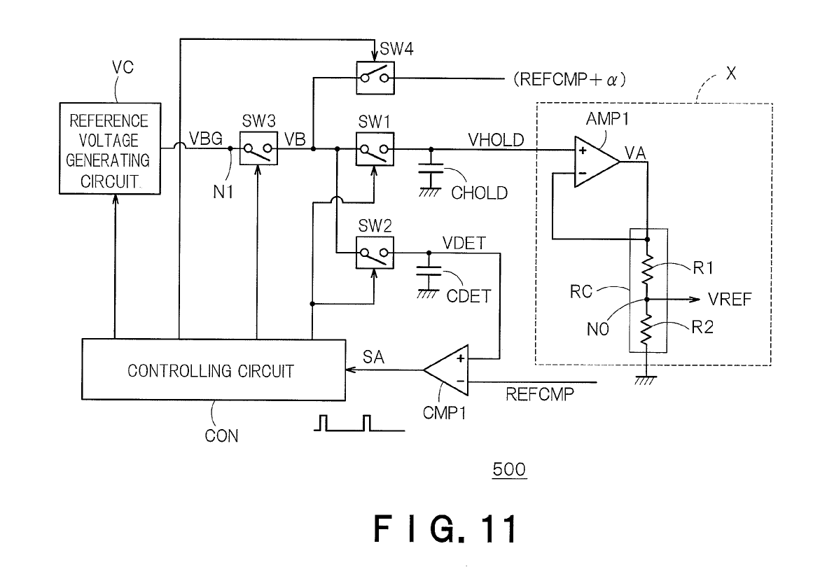

FIG. 11 is a circuit diagram showing an example of a configuration of a reference circuit 500 according to a fifth embodiment. In FIG. 11, the same reference symbols as those in FIG. 9 denote the same components as those in the fourth embodiment, and description of the components will be omitted.

As shown in FIG. 11, as with the reference circuit 400 according to the fourth embodiment, the reference circuit 500 includes the reference voltage generating circuit “VC”, the first switch element “SW1”, the second switch element “SW2”, the first capacitive element “CHOLD”, the second capacitive element “CDET”, the output circuit “X”, the comparator “CMP1”, and the controlling circuit “CON”.

The reference circuit 500 according to the fifth embodiment differs from the reference circuit 400 according to the fourth embodiment in that the reference circuit 500 further includes the third switch element “SW3” and the fourth switch element “SW4”.

A current path of the third switch element “SW3” is connected between the first node “N1” and the one ends of the first and second switch elements “SW1” and “SW2”. The third switch element “SW3” operates under the control of the controlling circuit “CON”.

The fourth switch element “SW4” is connected the one ends of the first and second switch elements “SW1” and “SW2” at one end of a current path thereof, and a control voltage (REFCMP+α) is applied to another end of the current path. The fourth switch element “SW4” operates under the control of the controlling circuit “CON”.

As in the fourth embodiment, the comparator “CMP1” compares the detected voltage “VDET” correlated with the hold voltage “VHOLD” with the comparison voltage “REFCMP” and outputs the comparison result signal “SA” in accordance with the result of the comparison.

As in the fourth embodiment, the comparison voltage “REFCMP” is input to the inverting input terminal of the comparator “CMP1”, and the detected voltage “VDET” is input to the non-inverting input terminal of the comparator “CMP1”.

The control voltage (REFCMP+α) is set to be higher than the comparison voltage “REFCMP”.

If the detected voltage “VDET” lies between the reference voltage “VBG” and the comparison voltage “REFCMP”, that is, if the detected voltage “VDET” is equal to or lower than the comparison voltage “REFCMP” in this embodiment, the comparison result signal “SA” indicates the first state described above, and the controlling circuit “CON” makes the reference voltage generating circuit “VC” stop operating, turns off the first to third switch elements “SW1” to “SW3” and then turns on the fourth switch element “SW4”.

As a result, supply of the reference voltage “VBG” to the first and second capacitive elements “CHOLD” and “CDET” is stopped, and the holding state is entered.

The voltage “VB” at the one ends of the first and second switch elements “SW1” and “SW2” then becomes equal to the control voltage (REFCMP+α) and is lower than the potential (power supply potential) of the reference voltage “VBG” in the holding state in the fourth embodiment. Thus, the potential difference between the terminals of the first and second switch elements “SW1” and “SW2” decreases, and the absolute values of the leak currents of the first and second switch elements “SW1” and “SW2” can be reduced.

After that, if the comparison result signal “SA” indicates the second state described above in which the detected voltage “VDET” has reached the comparison voltage “REFCMP”, the controlling circuit “CON” turns off the fourth switch element “SW4”, and then makes the reference voltage generating circuit “VC” operate for a predetermined period, and turns on the first to third switch elements “SW1” to “SW3”.

As a result, supply of the reference voltage “VBG” to the first and second capacitive elements “CHOLD” and “CDET” is started, and the sampling state is entered.

As described above, in the holding state, the voltage “VB” at the one ends of the first and second switch elements “SW1” and “SW2” is made equal to the control voltage (REFCMP+α) to control the voltages between the terminals of the first and second switch elements “SW1” and “SW2”.

In this way, the absolute values of the leak currents of the first and second switch elements “SW1” and “SW2” are reduced. As a result, the period of the holding state of the reference circuit 500 can be extended, and the consumed current can be reduced.

The remainder of the configuration of the reference circuit 500 is the same as that of the reference circuit 400 shown in FIG. 9.

The remainder of the operation of the reference circuit 500 configured as described above is the same as that of the reference circuit 400 according to the fourth embodiment.

That is, as with the reference circuit 400 according to the fourth embodiment, the reference circuit 500 according to the fifth embodiment can reduce the consumed current.

### Sixth Embodiment

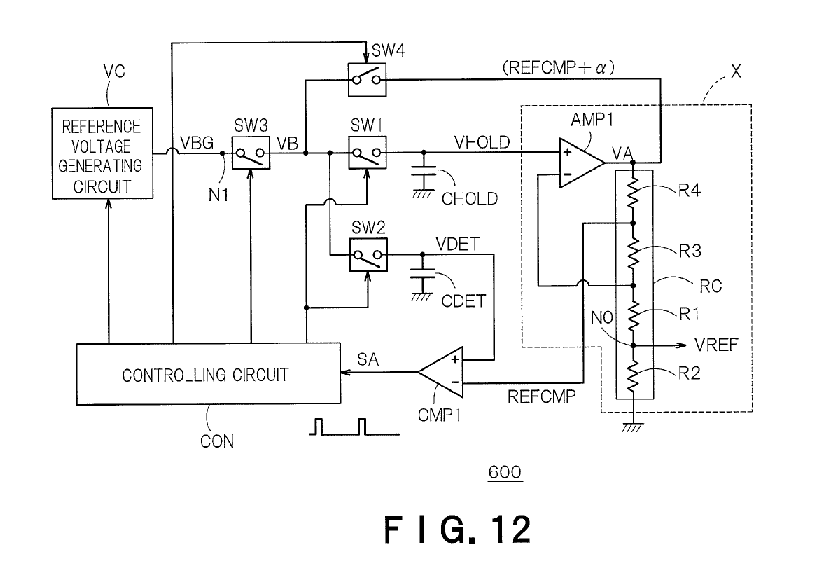

FIG. 12 is a circuit diagram showing an example of a configuration of a reference circuit 600 according to a sixth embodiment. In FIG. 12, the same reference symbols as those in FIG. 1 denote the same components as those in the first embodiment, and description of the components will be omitted.

As shown in FIG. 12, as with the reference circuit 500 according to the fifth embodiment, the reference circuit 600 includes the reference voltage generating circuit “VC”, the first switch element “SW1”, the second switch element “SW2”, the third switch element “SW3”, the fourth switch element “SW4”, the first capacitive element “CHOLD”, the second capacitive element “CDET”, the output circuit “X”, the comparator “CMP1”, and the controlling circuit “CON”.

According to the sixth embodiment, the voltage dividing circuit “RC” is connected between the output of the amplifying circuit “AMP1” and the fixed potential (ground potential).

The voltage dividing circuit “RC” outputs, as the reference voltage “VREF”, a voltage obtained by dividing the amplifier voltage “VA” output from the amplifying circuit “AMP1” in the first voltage dividing ratio. Furthermore, the voltage dividing circuit “RC” outputs a voltage obtained by dividing the amplifier voltage “VA” output from the amplifying circuit “AMP1” in a second voltage dividing ratio. Furthermore, the voltage dividing circuit “RC” outputs, as the comparison voltage “REFCMP”, a voltage obtained by dividing the amplifier voltage “VA” output from the amplifying circuit “AMP1” in a third voltage dividing ratio.

As shown in FIG. 12, the voltage dividing circuit “RC” includes the first resistive element “R1”, the second resistive element “R2”, a third resistive element “R3”, and a fourth resistive element “R4”, for example.

The fourth resistive element “R4” is connected to the output of the amplifying circuit “AMP1” at one end thereof and to the inverting input terminal of the comparator “CMP1” at another end thereof.

The third resistive element “R3” is connected to the another end of the fourth resistive element “R4” at one end thereof and to the inverting input terminal of the amplifying circuit “AMP1” at another end thereof.

The first resistive element “R1” is connected to the another end of the third resistive element “R3” at one end thereof and to the output node “NO” at which the reference voltage “VREF” is output at another end thereof.

The second resistive element “R2” is connected to the output node “NO” at one end thereof and to the fixed potential (ground potential) at another end thereof.

As described above, in the example shown in FIG. 12, the voltage dividing circuit “RC” outputs, as the reference voltage “VREF”, a voltage obtained by dividing the amplifier voltage “VA” in the first voltage dividing ratio determined by the first to fourth resistive elements “R1” to “R4”.

Furthermore, the voltage dividing circuit “RC” outputs a voltage obtained by dividing the amplifier voltage “VA” in the second voltage dividing ratio determined by the first to fourth resistive elements “R1” to “R4”.

Furthermore, the voltage dividing circuit “RC” outputs, as the comparison voltage “REFCMP”, a voltage obtained by dividing the amplifier voltage “VA” in the third voltage dividing ratio determined by the first to fourth resistive elements “R1” to “R4”.

In this example, the non-inverting input terminal of the amplifying circuit “AMP1” is connected to the one end of the first capacitive element “CHOLD”, and the voltage obtained by the voltage dividing circuit “RC” dividing the amplifier voltage “VA” in the second voltage dividing ratio is input to the inverting input terminal of the amplifying circuit “AMP1”.

The amplifying circuit “AMP1” controls the amplifier voltage “VA” so as to make the voltage obtained by the voltage dividing circuit “RC” dividing the amplifier voltage “VA” in the second voltage dividing ratio equal to the hold voltage “VHOLD”. The amplifier voltage “VA” is used also as the control voltage (REFCMP+α).

Since the reference circuit 600 provides the control voltage (REFCMP+α) to be supplied to the one ends of the first and second switch elements “SW1” and “SW2” for itself, the circuit that generates the control voltage (REFCMP+α) can be omitted.

Furthermore, since the reference circuit 600 provides the comparison voltage “REFCMP” for the comparator “CMP1” for itself, the circuit that generates the comparison voltage “REFCMP” can be omitted.

The remainder of the configuration of the reference circuit 600 is the same as that of the reference circuit 500 shown in FIG. 11.

The operation of the reference circuit 600 configured as described above is the same as that of the reference circuit 500 according to the fifth embodiment except that the comparison voltage “REFCMP” varies with the reference voltage “VREF” as in the second embodiment (FIG. 7).

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A reference circuit, comprising:
a voltage generating circuit that outputs a first voltage to a first node;
a first switch element that is connected to the first node at a first end of a current path thereof;
a first capacitive element that is connected to a second end of the current path of the first switch element at a first end thereof and to a fixed potential at a second end thereof;
an output circuit that outputs a third voltage that is based on a second voltage at the first end of the first capacitive element;
a comparator that compares a fourth voltage correlated with the second voltage and a fifth voltage and outputs a comparison result signal in accordance with a result of the comparison; and
a controlling circuit that controls operation of the voltage generating circuit and the first switch element in accordance with the comparison result signal.

2. The reference circuit according to claim 1, further comprising:
a second switch element that is connected to the first node at a first end of a current path thereof; and
a second capacitive element that is connected to a second end of the current path of the second switch element at a first end thereof and to the fixed potential at a second end thereof and has a capacitance smaller than a capacitance of the first capacitive element,
wherein the fourth voltage is a voltage at the first end of the second capacitive element, and
the controlling circuit
makes the voltage generating circuit stop operating and turns off the first switch element and the second switch element when the fourth voltage lies between the first voltage and the fifth voltage, and
makes the voltage generating circuit operate for a predetermined period and turns on the first switch element and the second switch element when the fourth voltage has been the fifth voltage.

3. The reference circuit according to claim 2, wherein the output circuit comprises:
an amplifying circuit that receives the second voltage and outputs an amplifier voltage in such a manner that a voltage that is related to the amplifier voltage and the second voltage are equal to each other; and
a voltage dividing circuit that is connected between an output of the amplifying circuit and the fixed potential and outputs, as the third voltage, a voltage obtained by dividing the amplifier voltage in a first voltage dividing ratio.

4. The reference circuit according to claim 2, wherein the output circuit comprises:
an amplifying circuit that receives the second voltage and outputs an amplifier voltage in such a manner that a voltage that is related the amplifier voltage and the second voltage are equal to each other, and
the amplifying circuit controls the amplifier voltage the second voltage are equal to each other and outputs the output voltage of the amplifying circuit as the third voltage.

5. The reference circuit according to claim 2, further comprising:
a third switch element whose current path is connected between the first node and the first end of the first switch element and that operates under the control of the controlling circuit; and
a fourth switch element that is connected to the first end of the first switch element at a first end of a current path thereof, a control voltage being applied to a second end of the current path, and the fourth switch element operating under the control of the controlling circuit.

6. The reference circuit according to claim 5, wherein the control voltage is a voltage in accordance with the fifth voltage.

7. The reference circuit according to claim 2, wherein a inverting input terminal of the comparator is connected to the first end of the second capacitive element, and
the fifth voltage is input to an non-inverting input terminal of the comparator.

8. The reference circuit according to claim 2, wherein a non-inverting input terminal of the comparator is connected to the first end of the second capacitive element, and
the fifth voltage is input to an inverting input terminal of the comparator.

9. The reference circuit according to claim 7, further comprising:
a third switch element whose current path is connected between the first node and the first end of the first switch element and that operates under the control of the controlling circuit; and
a fourth switch element that is connected to the first end of the first switch element at a first end of a current path thereof, a control voltage being applied to a second end of the current path, and the fourth switch element operating under the control of the controlling circuit,
wherein the control voltage is a voltage in accordance with the fifth voltage and is lower than the fifth voltage.

10. The reference circuit according to claim 8, further comprising:
a third switch element whose current path is connected between the first node and the first end of the first switch element and that operates under the control of the controlling circuit; and
a fourth switch element that is connected to the first end of the first switch element at a first end of a current path thereof, a control voltage being applied to a second end of the current path, and the fourth switch element operating under the control of the controlling circuit,
wherein the control voltage is a voltage in accordance with the fifth voltage and is higher than the fifth voltage.

11. The reference circuit according to claim 5, wherein the control voltage is the amplifier voltage or a voltage obtained by dividing the amplifier voltage.

12. The reference circuit according to claim 3, wherein a non-inverting input terminal of the amplifying circuit is connected to the first end of the first capacitive element, and
the voltage obtained by dividing the amplifier voltage in a second voltage dividing ratio is input to an inverting input terminal of the amplifying circuit.

13. The reference circuit according to claim 3, wherein the fifth voltage is the amplifier voltage or a voltage obtained by dividing the amplifier voltage.

14. The reference circuit according to claim 3, wherein the voltage dividing circuit comprises:
a first resistive element that is connected to the output of the amplifying circuit at a first end thereof and to an output node at which the third voltage is output at a second end thereof; and
a second resistive element that is connected to the output node at a first end thereof and to the fixed potential at a second end thereof.

15. The reference circuit according to claim 1, wherein the comparator has a hysteresis characteristic.

16. The reference circuit according to claim 2, wherein a leak current of the second switch element in an off state is proportional to a leak current of the first switch element in the off state.

17. The reference circuit according to claim 2, wherein a leak current of the second switch element in an off state is equal to a leak current of the first switch element in the off state.

18. The reference circuit according to claim 2, wherein the fixed potential is a ground potential.

19. The reference circuit according to claim 2, wherein the second capacitive element has a capacitance smaller than a capacitance of the first capacitive element.
